(19) United States
(12) Patent Application Publication
(10) Pub. No.: US 2005/0257704 A1
(43) Pub. Date: Nov. 24, 2005

(54) Method for lateral adjustment of a directly driven load without shifting the entire drive assembly

(76) Inventors: Jon Vander Pas, Appleton, WI (US); Dale E. Zeman, Denmark, WI (US); Robert W. Braun, Appleton, WI (US)

Correspondence Address: John W. Chestnut;GREER, BURNS & CRAIN, Suite 2500, 300 South Wacker Drive, Chicago, IL, 60606-4002, US

(21) Appl. No.: 10/849,763

(22) Filed: May 21, 2004

(51) Int. Cl. B41F 5/00

(52) U.S. Cl. 101/216

(57) ABSTRACT

This invention uses a combination of a rotor (rotating) component of an electromagnet motor that is integrated as part of a driven rotational load and immersed within an longer stator (stationary) component of the motor allowing for axial motion of the load (rotor) independent of the motor stator and housing. An alternative covered by this disclosure is a rotor that is longer relative to the length of the stator. The directly driven load provides improved rigidity for torque transmission and superior control performance. The axial motion capability lends itself to other functions such as printing sleeve removal for exchange purposes in a flexographic press.

### BACKGROUND

This invention relates to the method by which a load driven by an electromagnetic motor is shifted axially without shifting the entire assembly comprised of motor and load. The premise of the invention is the application of frame-less motor technology in a unique and novel manner. While this invention is discussed in the context of a flexographic press, it can also be used on other forms of presses and rotary load applications where static and dynamic axial adjustments of the load are required.

Printing presses such as flexographic presses include one or more rolls adjacent to a cylinder. Each roll is responsible for printing an image. For example, a flexographic press typically has multiple printing (plate) rolls around a central impression cylinder. Each roll is dedicated to applying an image to a substrate, the substrate being supported by the central cylinder. The individual images, when printed properly relative to each other, form the desired graphics for the end product. In addition to the plate roll, a means of metering ink to the plate roll is required. A roll designed to control the volume and density of ink applied to the plate roll performs this function. The inking roll is commonly referred to as an anilox roll. For flexographic presses, the printing roll (a.k.a. plate roll) and the inking roll (a.k.a. anilox) along with any periphery devices comprise a printing deck.

On any given deck, the plate roll carries the printed image and applies it to the captured substrate. Depending on the design, these rolls can be integral cylinders or they can be mandrels that accept specialized sleeves. In the case of integral cylinders, the printer precisely wraps the plates that contain the print image around the entire cylinder when it is out of the machine. In a mandrel design, plate sleeves are mounted onto mandrels that are permanently mounted in the machine. This mounting is typically assisted by pressurized air exhausted through ports in the mandrel.

In this arrangement, the plate and anilox rolls can be mechanically or electronically geared to the impression cylinder in order to ensure that the rolls maintain their circular position relationships. In either situation, synchronizing motion is required to insure high quality printed images. A typical mechanically geared system uses a single motor to drive the impression cylinder that, in turn, transmits torque to the plate and anilox rolls via mechanical gears. In an electronically geared situation, position profiles are synchronized without mechanical linkages between the rolls. Position synchronization is accomplished by virtue of a motion controller that coordinates motion based on interpretation of position feedback signals. Because control is accomplished without the use of mechanical gears, this scheme is commonly referred to as gear-less control. In both the mechanical and electronic designs, the printing process requires the capability to adjust the position of the individual images in both the machine and in the cross-machine (transverse) directions. To provide electronically geared control, electromagnetic motors are commonly used to independently drive the plate cylinders.

While driving the plate cylinders with independent motors provides flexibility for machine direction adjustments, complexity is added to cross machine adjustments. In the present art, transverse plate adjustments require shifting the plate cylinder and motor in their entirety. Shifting the motor axially requires a means (e.g. linear rails) to maintain the alignment of the load and motor. In addition to the side shift linear bearings, there is an intermediate bracket that attaches to a second set of linear bearings to permit impression adjustments of the nips between the anilox, plate, and impression cylinder respectively.

The result of all of these motions and bearings are a complicated set of brackets and controls that is expensive, difficult to assemble takes considerable room and compromises rigidity. In this context, rigidity refers to torsion rigidity of the motor rotor to the mandrel, torsion rigidity of the supporting structure and linear rigidity of the support structure. In this part of the press, rigidity has a major impact on print quality and print speed. It also has an impact on motor size and drive tuning.

In a conventional gear-less press, a servomotor drives the roll or mandrel through a coupling. While this technology is essentially mature, extreme care must be taken to control the motor rotor inertia to the mandrel and print sleeve inertia mismatch and coupling rigidity in order to get good printing performance. In order to minimize the effects of inertial mismatches between motor rotor and load, many electromagnetic motor manufacturers offer the components of motors separately for integration into a mechanical design. This offering is commonly referred to as frame-less motor technology.

### SUMMARY OF THE INVENTION

The invention integrates frame-less motor technology in order to take advantage of the generally accepted benefits of this technology while providing improved mechanical rigidity and flexibility. Frame-less motor technology is characterized by the integration of the components of an industrial motor directly into the design without the use of mechanical couplings. The rotating portion of the motor (commonly referred to as the “rotor”) is directly connected to the load. The rotor and load combination is inserted into the stationary portion of the motor (commonly referred to as the “stator”). Under electromagnetic control, the rotor (load) rotates by virtue of electromagnetic forces. The absence of mechanical couplings results in superior rigidity between the electromotive force and the load. Thus, more responsive control performance is achievable.

The key differentiation between this application and other applications involving frame-less motor technology lies in its utilization of an oversized rotor or stator. Through the use of a stator or rotor that is longer than the corresponding rotor or stator, axial translation of the load can be accomplished without moving the entire motor. The rotor and load combination is shifted independent of the stator and overall housing. This method capitalizes on the generally accepted benefits of frame-less designs, while increasing the rigidity of the design because it is more direct and simple. As an ancillary benefit on printing presses utilizing plate sleeves, the side actuation provides a simple means of dislodging the sleeves to facilitate removal and replacement. Replacement of print sleeves is necessary when switching the graphical image produced by the process overall.

### DESCRIPTION OF THE drawing

The invention will be explained in conjunction with the illustrative embodiments shown in the accompanying drawing, in which—

FIG. 1 is a front elevation view of a conventional flexographic printing press;

FIG. 2 is a side elevation view of a flexographic printing press that is equipped with a side shift mechanism in accordance with this invention with the plate and anilox rolls shown in the printing position;

FIG. 3 is a side elevation view of a flexographic press of FIG. 2 shown in a non-printing position;

FIG. 4 is a top view taken along the line 4-4 of FIG. 2 of the plate mandrel arrangement in the printing position that illustrates the components necessary for shifting the plate mandrel axially, independent of the motor housing;

FIG. 5 is a side view taken along the line 5-5 of FIG. 2 of the plate mandrel arrangement in the printing position;

FIG. 6 is a side view taken along the line 6-6 of FIG. 3 of the plate mandrel arrangement in the sleeve exchange position;

FIG. 7 is as top view taken along the line 7-7 of FIG. 3 of the plate mandrel arrangement in the sleeve exchange position; and

FIG. 8 is an enlarged fragmentary view of the motor and mandrel of FIGS. 4-7.

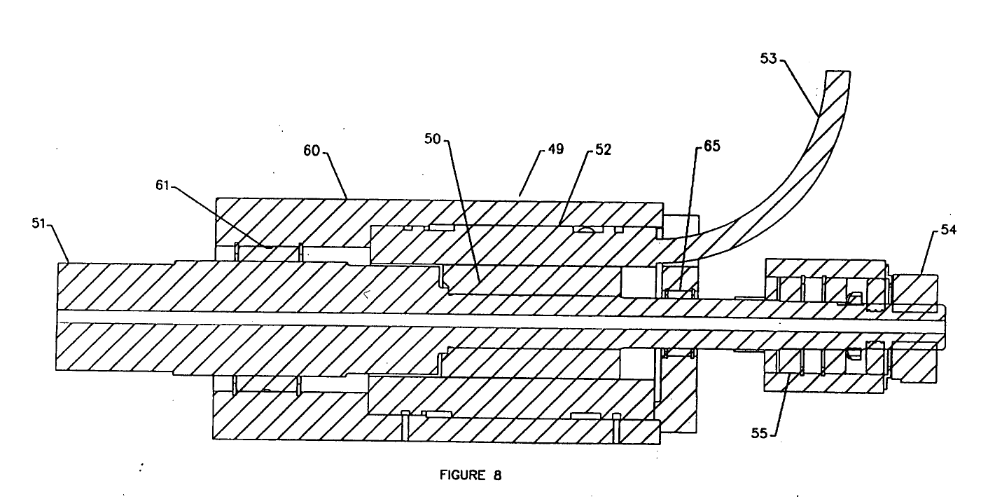

### DESCRIPTION Of SPECIFIC EMBODIMENTS

The invention will be explained in conjunction with a flexographic printing press that uses an anilox roll to transfer printing ink from an ink fountain to a plate roll that prints an image on a web or substrate. However, it will be understood that the invention can be used with other types of presses or in any application that requires an axial shift of a load driven directly by an electromagnetic motor.

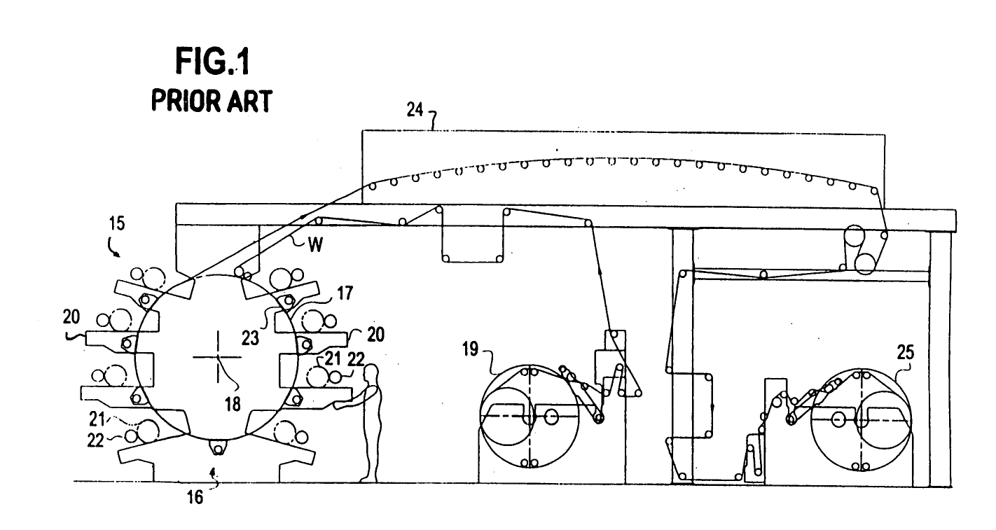

FIG. 1 illustrates a conventional flexographic press 15 which includes a front frame 16, a rear frame (not shown) and a central impression (CI) drum or cylinder 17 which is rotatably mounted in the frames for rotation about its central axis 18. A web W is conveyed from an unwind stand 19 to the CI drum and is supported by the drum as the drum rotates.

A plurality of print decks or color decks 20 are mounted on the frames around the periphery of the CI drum 17. Each deck includes a plate roll 21 and an anilox roll 22 that are rotatably mounted on the deck. An ink fountain (not shown) on the deck supplies ink to the anilox roll, and the anilox roll transfers the ink to the plate roll. The plate roll prints an image on the web W as the web moves past the plate roll on the rotating CI drum. Between color dryers 23 are mounted between adjacent color decks, and the fully printed web is conveyed through a tunnel dryer 24 and rewound on rewind stand 25.

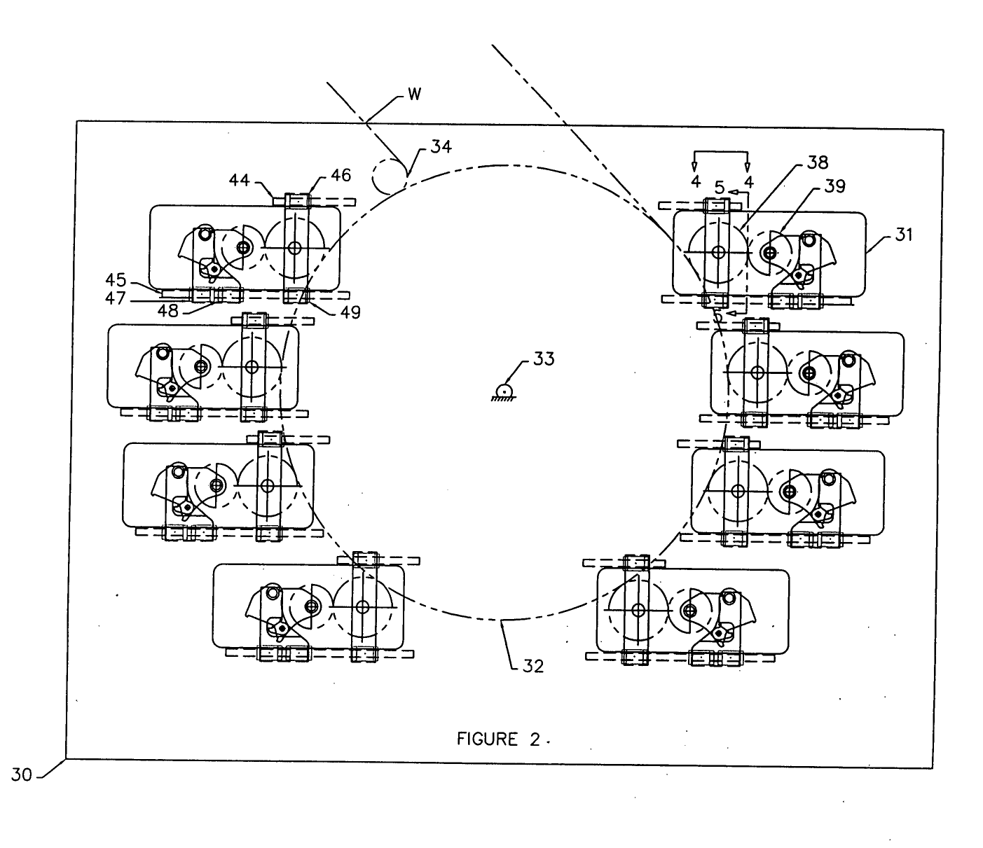

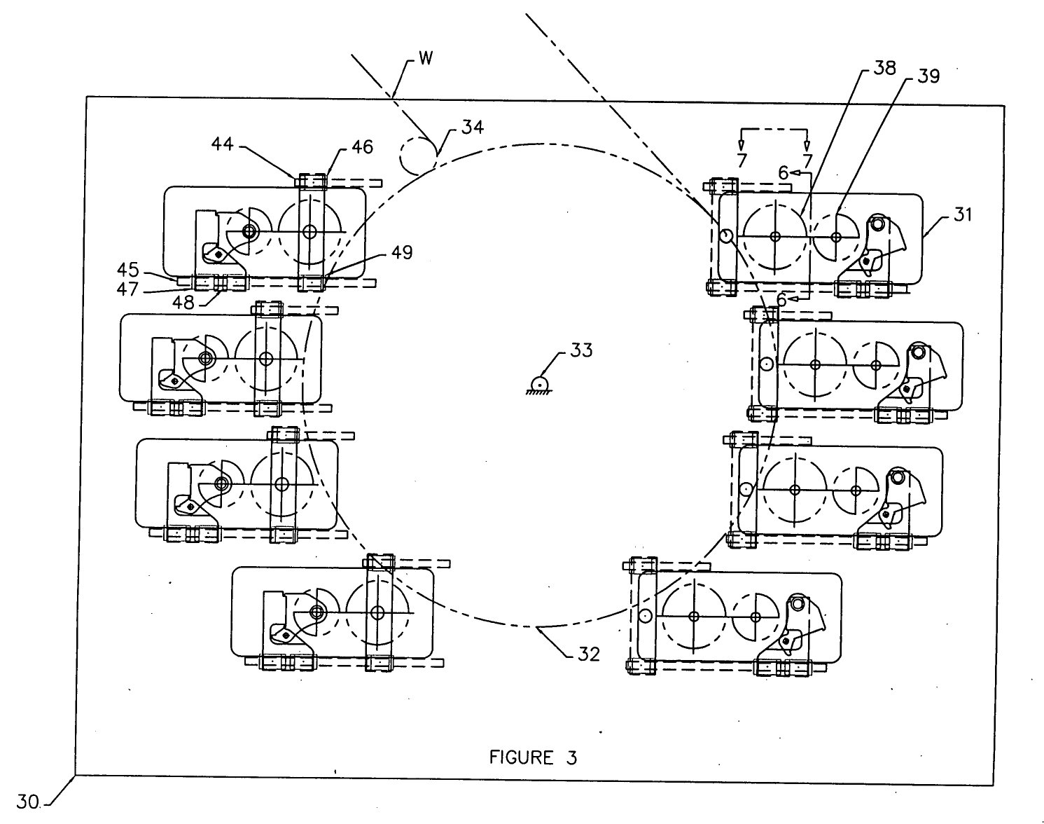

FIGS. 2 and 3 illustrate a flexographic press section 30 with color decks 31 that include side shift mechanisms in accordance with the invention. The press 30 includes a central impression (CI) drum 32 which is rotatably mounted in bearings 33 which are supported on the front and back frames (not shown) of the press. A web W passes over a lay down roll 34 and rotates with the CI drum 32.

Each of the color decks 31 includes a plate roll 38 and an anilox roll 39 which are supported by linear bearings 46, 47, 48, 49 that ride on parallel linear rails 44 and 45 mounted to the front and back frames of the press.

FIG. 2 shows the plate rolls 38 and anilox rolls 39 in their racked-in position in which the plate roll is contacting the surface of the CI drum and applying ink transferred from the anilox roll 39 to the web W. FIG. 3 shows the plate and anilox rolls in their racked out positions. In the racked out position, space exists between the plate roll 38 and the CI drum 32 and between the plate roll 38 and the anilox roll 39.

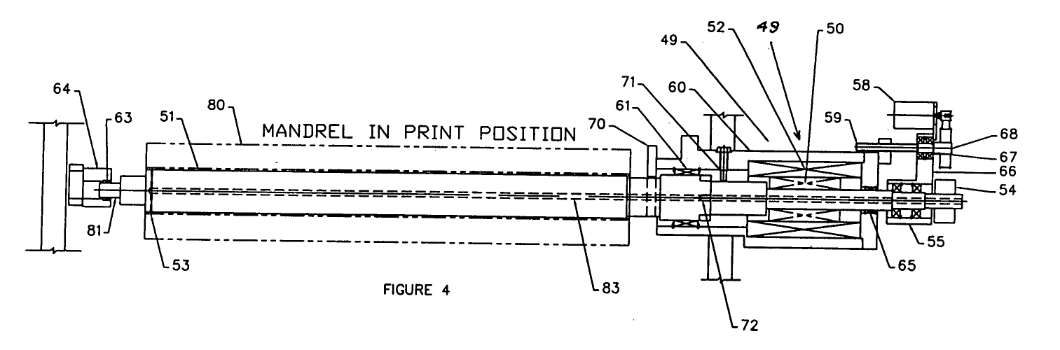

FIG. 4 shows a representation of the top view of the plate roll taken along the line 4-4 of FIG. 2. A motor 49 includes a rotor (rotating) component 50 which is affixed to a plate roll or mandrel 51. A stator (stationary) component 52 of the motor is inserted into and affixed to a motor housing 60. The stator 52 is oversized, i.e. axially longer, relative to the rotor component 50. The rotor and mandrel assembly is inserted through the housing and stator assembly and is supported within housing 60 by rotational bearings 61 and 65 and the end bearing 63 and the end bearing support 64. The bearings 61 and 65 may include conventional seals. Due to the oversized nature of the stator 52 relative to the rotor 50, the mandrel and rotor assembly is able to side shift within the oversized stator.

A rotary feedback device 54 is mounted on the end of the mandrel shaft 51 to allow for electrical control. The rotary feedback device 54 may provide signals to a conventional motion controller for controlling the speed and synchronization of the rotor relative to the rotors of the other print decks.

The rotor 50 and stator 52 can be purchased from Indramat GmbH. The stator 52 includes conventional electric motor windings which are connected to a power source by leads 53. The rotor 50 includes a conventional magnet, and the rotor is rotated by electromagnetic sources.

Referring to FIG. 4, mandrel axial positioning bearings 55 are mounted on the mandrel. The loading of these bearings against the mandrel shaft 51 facilitates movement of the entire mandrel given an axial force transmitted by the bearing assembly. In FIG. 4, the axial force is transmitted by a connection plate 66 that moves along a captured threaded shaft 59 by means of a side shift bearing 67. The threaded shaft is shown rotatably driven by adjustment stepper motor 58 and adjustment device 68. Other actuating means could be used to provide the axial shifting force, for example, an air cylinder. Here, the adjustment motor 58 drives the threaded shaft 59 that results in motion of the axial positioning bracket 66. The bracket 66 by virtue of its connection with the axial positioning bearing assembly 55, in turn, transmits the axial force that translates the rotor and mandrel assembly within the stator and housing assembly.

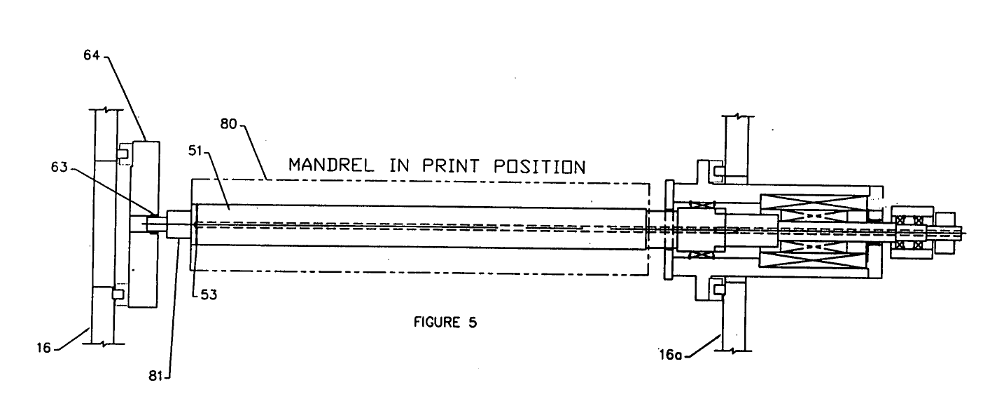

FIG. 5 shows an enlarged representation of the side view of the plate roll taken along the line 5-5 of FIG. 2. In this view, the plate mandrel is shown supported by the bearing 63 in bearing housing 64. When a sleeve exchange is initiated, air is forced through ports 53 in the mandrel 51 to facilitate removal of the sleeve 80. The rotor and mandrel assembly is subsequently shifted axially toward the motor housing by the previously described actuation. This motion results in the front end 81 of the mandrel separating from the front bearing 63 and housing 64.

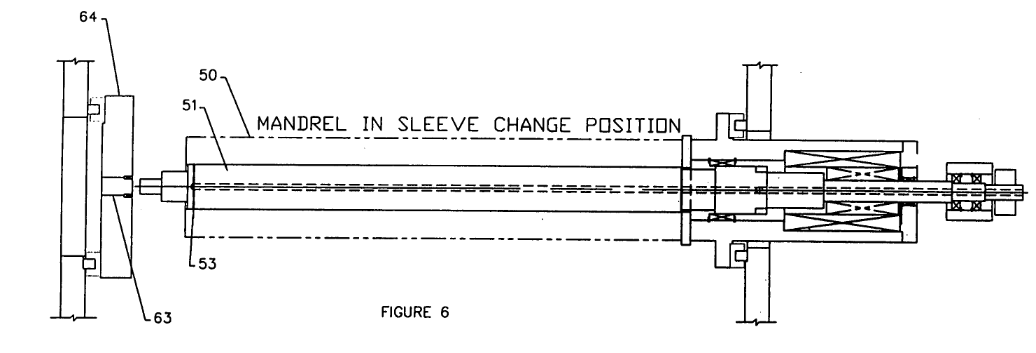

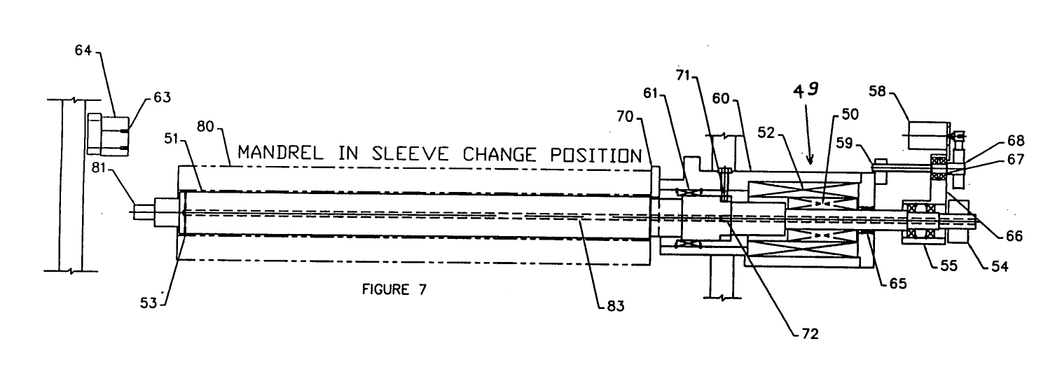

FIG. 6 shows the results of the axial motion to shift the front end 81 of the mandrel away from the bearing 63 and bearing housing 64. The bearing 63, along with the bearing housing 64, are then shifted toward the surface of the CI drum 32 as shown in FIG. 7. This positioning allows the operator to either free the sleeve manually or proceed with an automated push of the sleeve. If manual removal is desired, the sleeve can be rotated such that a locking pin 71 on the housing 60 mates with one of a plurality of slots 72 in the mandrel in order to restrict rotational movement when forcibly removing the sleeve 80. If an automated sleeve exchange is desired, the mandrel 51 can be further retracted such that the sleeve is forced against a sleeve pusher 70 on the housing 60 and dislodged from the mandrel. The mandrel 51 is then returned to the previous exchange position such that the pusher mechanism 70 is no longer restricting full sleeve insertion. The operator can then easily remove the sleeve 80 from the mandrel 51.

The operator can now insert a new sleeve 80 onto the mandrel 51. Once the sleeve 80 is inserted on the mandrel 51, the porting of air through holes in the mandrel 53 is discontinued. The front bearing 63 and bearing support 64 transition from the position of FIG. 7 to the position of FIG. 4. The mandrel 51, sleeve 80, and entire mandrel assembly is then shifted axially toward the bearing 63 and bearing support 64 until the front of the mandrel 51 is once again supported. The operator is now able to position the mandrel relative to the CI drum in accordance with the state of the art of flexographic presses.

In the preferred embodiment, the stator 52 is longer than the rotor 50. However, the rotor could be longer than the stator. In either case, the rotor can be shifted axially relative to the stator without affecting the electromagnetic forces which rotate the motor. The motor can therefore be operated throughout the range of axial adjustment of the rotor.

The bearing support 64 is mounted on the front frame 16 of the press (FIG. 5), and the motor housing 60 is mounted on the rear frame 16a of the press.

1. An axially adjustable rotating assembly comprising:
a rotatable member,
an electromagnetic motor including an axially extending stator and an axially extending rotor within the stator, one of the stator and the rotor having an axial dimension greater than the axial dimension of the other, the rotatable member being connected to the rotor and the rotatable member and the rotor being rotatable by rotational forces derived from electromagnetic forces between the rotor and the stator, and
supporting bearings supporting the rotatable member and the rotor for axial movement relative to the stator.

2. The structure of claim 1 in which the axial dimension of the stator is greater than the axial dimension of the rotor.

3. The structure of claim 1 including a housing which encapsulates the rotor and the stator.

4. The structure of claim 1 including a rotational feedback device mounted on the rotatable member.

5. The structure of claim 1 including a screw operatively connected to the rotor for shifting the rotor axially relative to the stator.

6. The structure of claim 5 including a stepper motor for rotating the screw which, in turn, causes the rotor to shift axially.

7. The structure of claim 1 including an air cylinder connected to the rotor for shifting the rotor axially relative to the stator.

8. A printing roll drive mechanism comprising:
a rotatable member having a front and a rear,
an electromagnetic motor including an axially extending stator and an axially extending rotor within the stator, the stator having an axial dimension greater than the axial dimension of the rotor, the rotatable member being connected to the rotor and the rotatable member and the rotor being rotatable by rotational forces derived from electromagnetic forces between the rotor and the stator,
supporting bearings supporting the rotatable member and the rotor for axial movement relative to the stator,
a front bearing for supporting the front of the rotatable member, and
means for moving the rotatable member and the rotor axially between a first position in which the front bearing rotatably supports the front of the rotatable member and a second position in which the front bearing does not support the front of the rotatable member.

9. The mechanism of claim 8 in which the means for moving includes a screw operatively connected to the rotor for shifting the rotor axially relative to the stator.

10. The mechanism of claim 9 in which the means for moving includes a stepper motor for rotating the screw which, in turn, causes the rotor to shift axially.

11. The mechanism of claim 8 in which the means for moving includes an air cylinder connected to the rotor for shifting the rotor axially relative to the stator.

12. The mechanism of claim 8 including a housing which encapsulates the rotor and the stator.

13. The mechanism of claim 8 including a rotational feedback device mounted on the rotatable member.

14. In a printing press having a frame,
a mandrel rotatably supported by the frame and having a front end and a rear end for mounting a removable sleeve,
an electromagnetic motor including a rotor and a stator, the stator having an axial dimension greater than the axial dimension of the rotor, the rotor being affixed directly to the mandrel and the resulting rotor and mandrel assembly being inserted into the stator, the rotor and mandrel assembly being driven by rotational forces derived from the electromagnetic forces between the rotor and the stator,
supporting bearings supporting the mandrel and the rotor for axial shifting of the rotor within the stator,
a bearing assembly for supporting the front end of the mandrel,
a housing that encapsulates the rotor, stator, and rear end of the mandrel, and
a physical stop on the frame for dislodging a sleeve when the mandrel is shifted axially.

15. The printing press of claim 14 including a screw connected to the rotor for shifting the rotor axially relative to the stator.

16. The printing press of claim 15 including a stepper motor for rotating the screw which, in turn, causes the rotor to shift axially.

17. The printing press of claim 14 including an air cylinder connected to the rotor for shifting the rotor axially relative to the stator
